(19) United States
(12) Patent Application Publication
(10) Pub. No.: US 2016/0328730 A1
(43) Pub. Date: Nov. 10, 2016

(54) METHOD, SYSTEM AND APPLICATION FOR ACKNOWLEDGING CONTENT AND PROVIDING REWARD OPPORTUNITIES TO A USER DEVICE

(71) Applicant: Perk.com US Inc., Austin, TX (US)

(72) Inventors: Adam A. Salamon, Austin, TX (US); Surojit Niyogi, Austin, TX (US)

(21) Appl. No.: 15/145,458

(22) Filed: May 3, 2016

Related U.S. Application Data
(60) Provisional application No. 62/157,756, filed on May 6, 2015.

(51) Int. Cl. G06Q 30/02

(52) U.S. Cl. CPC G06Q 30/0207; G06Q 30/0246

(57) ABSTRACT

Methods, systems and/or applications for providing reward and other opportunities to a user and/or user device for acknowledging content such as e.g., advertisements, audio, video, and textual content.

### CROSS REFERENCE TO RELATED APPLICATION

This application claims priority to U.S. Provisional Application Ser. No. 62/157,756, filed May 6, 2015, the entirety of which is incorporated herein by reference.

### FIELD OF THE INVENTION

The disclosed embodiments relate to and provide methods, systems and/or applications for providing reward and other opportunities to a user and/or user device for acknowledging content such as e.g., advertisements, audio, video, and textual content.

### BACKGROUND

People are inundated with advertisements in many settings of public and private life. Whether browsing the Internet, listening to the radio, watching television, taking public transportation, etc., advertisements are so ubiquitous that many people consciously or unconsciously overlook the advertisements they encounter. The same applies to other forms of content such as e.g., audio, video, and textual content on other types of media.

Accordingly, there is a need and desire to have advertisements and other forms of content viewed and acknowledged so that the advertiser, publisher, etc. knows that its content is being viewed and/or interacted with.

### SUMMARY

The innovations described herein solve the aforementioned problems by rewarding users who engage with and acknowledge the content (e.g., advertisements) they encounter. It should be appreciated that while the following description refers to advertisements and advertisers, these are merely examples in which the disclosed principles may be applied to. That is, the disclosed principles also apply to other content such as e.g., audio, video, and textual content on any form of media in which the publisher/producer of said content desires someone to listen to, view, read and/or interact with.

In accordance with the disclosed principles, by rewarding users who engage with and acknowledge the content (e.g., advertisements) they encounter, producers of the content (e.g., advertisers) increase user engagement with their content (e.g., advertisements) while users are provided a benefit as well. The disclosed embodiments relate to and provide for the acknowledgement of content (e.g., an advertisement) and any reward opportunities (e.g., discount coupons, gift cards, cash, currency, free items and virtual goods, videos, access to premium content, the unlocking of features to a website or other service, or various forms of vouchers or loyalty points that can be exchanged for any of the foregoing) when the user views/interacts/senses/engages with the content (e.g., advertisement). In the field of advertisements, for example, a direct reward may also be given by the advertiser, such as a free item, coupon, digital reward, digital coupon, voucher, etc., if the user acknowledges the advertisement.

In one embodiment, the disclosed principles provide a method of acknowledging content from a user device. The method comprises using a component of the user device to detect an indicator associated with the content; transmitting, from the user device, an acknowledgement that the indicator has been detected, the acknowledgement being transmitted to a server computer adapted to determine whether a reward should be provided to the user device based on the transmitted acknowledgement; and receiving, at the user device, the reward from the server computer when it is determined that the reward should be provided to the user device.

In another embodiment, the disclosed principles provide a method of rewarding a user for engaging with content. The method comprises receiving, at server computer, an acknowledgement that the content was viewed or listened to by a user of a user device, the acknowledgement being received over a network connection; deriving, by a processor of the server computer, a benefit to the user based on the received acknowledgement and stored information associated with the content; and providing the benefit to the user device.

### BRIEF DESCRIPTION OF THE DRAWINGS

FIG. 1 illustrates an example system constructed in accordance with an embodiment disclosed herein and for implementing the methods disclosed herein.

FIG. 2 illustrates example processing performed by a device in accordance with an embodiment disclosed herein.

FIG. 3 illustrates example processing performed by a system server in accordance with an embodiment disclosed herein.

### DETAILED DESCRIPTION

The following description refers to advertisements and advertisers and providing rewards when an advertisement is acknowledged. It should be appreciated, however, that these are merely examples in which the disclosed principles may be applied to. That is, as discussed above, the disclosed principles also apply to other content such as e.g., audio, video, and textual content on any form of media in which the publisher/producer of said content desires someone to listen to, view, read and/or interact with.

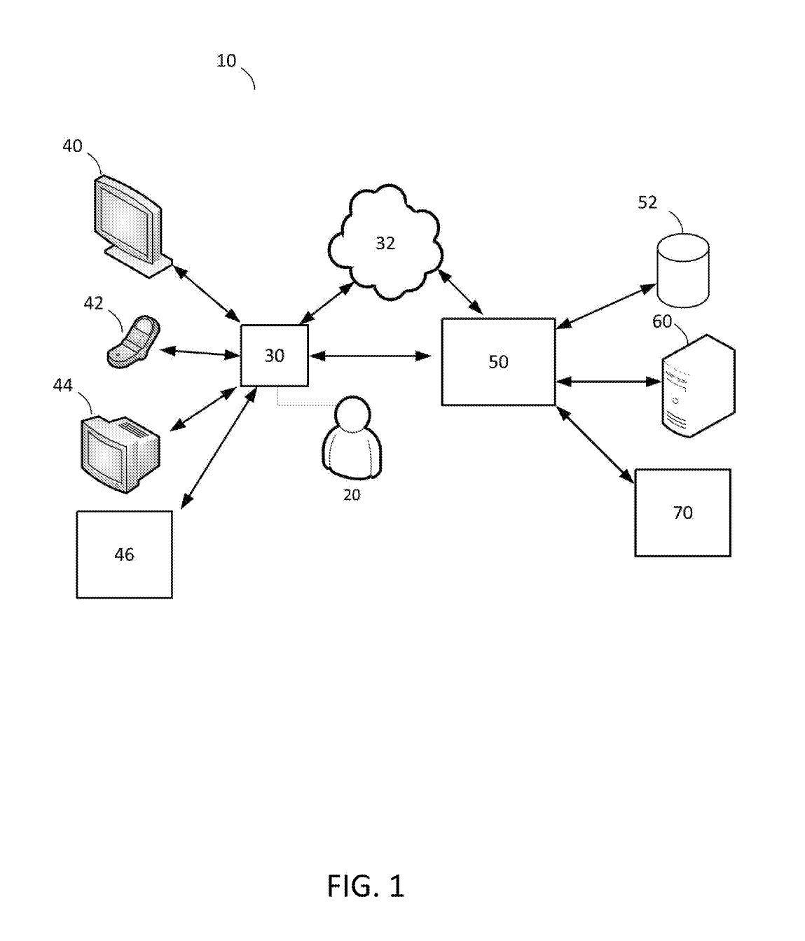

In the following example, systems, methods, applications and devices are described herein that provide a reward to a user upon recognition and acknowledgement that the user or its device has encountered a qualifying advertisement. FIG. 1 illustrates a network 10 according to an exemplary implementation of the disclosed principles. A user 20 and/or a user device 30 views/interacts/senses/engages at least one advertisement 40-46 in a suitable device/medium. The advertisement may be included on any article or any device capable of providing an advertisement, which includes, but is not limited to a TV advertisement 40, mobile advertisement 42, web advertisement 44, and other advertising media 46 including an offline banner, display advertisement, billboard, poster, magazine, publication, mail, radio advertisement, advertisements within wearable technology and the like. The advertising media that may be acknowledged may be any audio, visual, and audio/visual advertisement. The media includes offline and online advertisements.

In the illustrated example, the network 10 also comprises a system server 50 connected to the user device 30 by e.g., a wide area network shown in this embodiment as the Internet 32. The server 50 includes or is connected to a memory for storing computer instructions required to implement the method described herein (e.g., method 200 illustrated in FIG. 3) and to store the various databases, user information and login/account verification algorithms used during the above-described processes as well as the rewards earned by a user. For example, the server 50 may include a database 52 for user account information, reward information, and profile information, as well as a database of advertisers and advertisements that may be acknowledged by a user to receive a reward. The server 50 can be accessed over a wired or wireless network (shown as the Internet 32 in this example). User device 30 may include a mobile device and a laptop/PC that connect to the server 50 via the Internet/network or a cellular network. The server 50 can include input/output devices such as displays, scanners, printers, etc. (not shown).

The device 30 is not particularly limited and may be a mobile device such as e.g., a smartphone, PDA, wearable device, or a tablet; or a computing device such as e.g., a laptop or personal computer, to name a few. A desktop computer may be connected to the Internet 32 and provide a web interface for displaying the advertisement and allowing the user to acknowledge the advertisement. Examples of a wearable device include a prosthetic attached to a user, a smartwatch, earphones, headphones, health tracker, step counter, GPS device, body monitoring system, glasses, contacts and articles of clothing including sensors and processing capable of detecting and acknowledging an advertisement according to the disclosed principles. The wearable devices described herein may be worn by a user, permanently or removably attached to a body, clothing or accessory worn by the user, or within a predetermined proximity to a user and may include any device that functions as an addition or extension to the human body. The device 30 may be e.g., an embedded chip within an article of clothing or within the human body or other accessory worn by the user. Recognition and detection of an advertisement may be provided through at least one sensor and any necessary processors and memory of the device 30.

The device 30 may detect an advertisement utilizing any number of sensors and processes including visual content recognition, audio content recognition (ACR), a QR code, other code identifier, PIN number, pass phrase, pass code, code word, or other specific human entered code. For instance, a camera in a mobile device may capture an image of a physical advertisement including a QR code for a predetermined web link. An image captured by a camera may be analyzed to recognize particular shapes, codes, logos, keywords, numbers, features and other characteristics through optical character recognition and other image processing techniques to detect a predetermined advertisement.

Audio content recognition may include a microphone or equivalent sensor for capturing audio and determining that the audio corresponds to an advertisement. Geolocation provided by a GPS device may also be used to detect user engagement with an advertisement. The user may also input an acknowledgement of the advertisement to the device 30 by any known input method or any analog scenario, such as by touch, voice, biometric input, and the like.

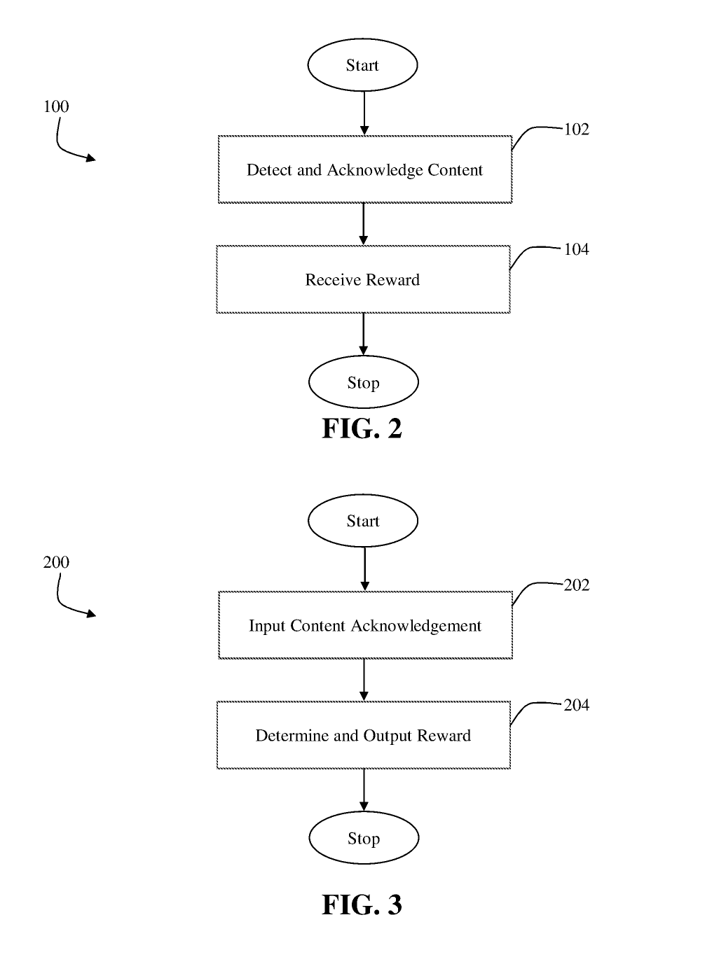

In one implementation, the disclosed system and methods can be implemented using an application program that can be downloaded onto a mobile device such as device 30 (e.g., smartphone, PDA, wearable device, or tablet) and accessed by the user via the mobile device 30. The application program will cause the mobile device 30 to interact with the system server 50 to perform the method disclosed herein (e.g., method 100 illustrated in FIG. 2). In another embodiment, the disclosed system and method can be implemented via a website (e.g., “Perk.com”) over the Internet 32 operated by a server 50 accessible by the user device 30. The device 30 may be connected to the Internet 32 as a delivery mechanism for the recognition of the advertisement and for obtaining the corresponding reward.

According to one implementation and with reference to the methods 100, 200 illustrated in FIGS. 2 and 3, processing and acknowledgement of a detected advertisement may be performed as follows. The user 20 may activate an application on the device 30 and then login to a reward program from the application executing on the device 30. The user may execute an application or program previously downloaded and log in using that application/program; alternatively, the user may use any device to log into the system via the Internet. The user may login through a social media account or by using other credentials (e.g., username and password). As can be appreciated, the system/method disclosed herein will input and store usernames and passwords as part of an account setup procedure. The user's account is then associated with profile information, advertisement acknowledgement information, and or other information related to the particular user. The stored account information will also be used to allocate and track reward opportunities that the user has earned through acknowledging advertisements. The application may provide a login for existing users and a sign up process for acquiring new users. The sign up process may include a tutorial to teach the user how advertisements are acknowledged by the device 30. Some advertisements may include information directing a user to download the application. In one embodiment, the detecting of an advertisement by e.g., taking the image of a QR code, causes an account login and registration page to appear on the user's device, allowing a new user to create an account at the same time it acknowledged its first advertisement.

Once logged in, the user 20 may input the advertisement acknowledgement or allow the device 30 to detect the advertisements that the user engages or interacts with (step 102). The user may, for example, manually enter a code associated with a viewed advertisement on the device 30. Alternatively, or additionally, the user 20 may select an advertisement from a list of advertisements that offer reward opportunities. Advertisements provided on the device 30 are also monitored by the application. The server inputs the content acknowledgement from the device 30 (step 202), determines and outputs the appropriate reward (step 202), which is then input by the device (step 104).

It should be appreciated that the disclosed principles are not limited to registered users of the network 10 or users that login to the system disclosed herein. Accordingly, content may be acknowledged by any device regardless of whether the user or its device has an account with the network 10 or system server 50. The user or its device may still be rewarded based on a device ID, IP address or other form of identifier associated with the user or its device. Likewise, the user does not need to be affiliated with a reward or loyalty program of the network or system disclosed herein to receive a reward based on an interaction with content in accordance with the disclosed principles. In addition, a non-registered user can check into or interact with the disclosed system based on GPS information received from the user's device. Moreover, as described below, a non-registered user can check into or interact with the disclosed system based on information received from a wearable device 30 such as e.g., Google Glass.

It should also be appreciated that the disclosed principles can apply rewards, etc. in other situations as well. For example, a user can be provided with a particular reward, coupon, or discount, to name a few, by checking into a location, event or activity. The user can also check-in manually by confirming that he/she is at the location, event or activity upon detecting and acknowledging (via the user device) an audio or visual cue, code, etc. associated with the location, event or activity. The check-in could be performed automatically by automatic recognition (via the user device) of an audio or visual cue, code, etc. associated with the location, event or activity. Moreover, the user check-in can be performed by clicking on an online webpage or mobile application map identifying the location, event or activity. The map will be displayed along with a promotion or indicator advising the user to check-in and receive e.g., a reward.

According to an embodiment disclosed herein, a device and user are provided within the vicinity of an advertisement so that the device 30 can detect the advertisement using automatic content recognition including at least one of visual content recognition and audio content recognition. It should be appreciated that automatic content recognition could also be used to detect other content besides advertisements (such as e.g., audio, video, etc.) on any suitable medium in which the publisher/producer of said content desires someone to listen to, view, read and/or interact with.

Automatic content recognition provided by the device 30 may operate continuously or during predetermined periods of time (set by the system as a default time period, or by the user as a customized time period) to detect advertisements. A user 20 may be provided with a notification that automatic content recognition is active and listening for qualified advertisements. For example, the automatic content recognition technology will respond to audio that is detected by the device's microphone. Any type of hardware, device, circuitry, software, or combination thereof, can be used to implement the automatic content recognition required to implement the disclosed system and method. It should be appreciated that the automatic content recognition technology (including a microphone and camera in some examples) could be activated as soon as the user activates the application on the device 30 or logs into the system.

The acknowledgement received/detected by the device 30 is processed and then transmitted to the system server 50. Users may interface with the disclosed server 50 and execute portions of the disclosed method via a cellular network connection, WiFi connection, wired connection, wireless connection, and an Internet connection. The advertisement acknowledgement may be transmitted from the device 30 via Internet 32, radio or satellite, SMS or voice service, as well as a PUSH notification. The advertisement acknowledgement may be further transmitted by any messaging protocol such as email, for example. The disclosed system and method can be accessed using social media such as e.g., Twitter, Facebook, and other social networking technology. In one embodiment, the user can call in the acknowledgement of the advertisement from a phone (using a phone number associated with the specific advertisement or the system) to an operator associated with the server 50 or system in general.

Once the advertisement is detected by the device 30 and its acknowledgement is processed by the server 50, the server generates and provides a reward for the user. The benefits conferred upon a user upon acknowledgement of an advertisement are not particularly restrictive. Rewards may include currency, physical goods, vouchers, premium content, access or unlocking of something of value to the end user and virtual currency where the virtual currency may have real world value or only have virtual value. The user may be provided notification on their device 30 or a web interface on the status of their reward.

The acknowledgement data collected by the device 30 may be stored in the database 52 and/or provided to other third party servers 60 for market research, tracking and analysis. Compensation may be provided by the advertiser/agency or proxy 70 for providing the rewards to the user 20 by the server 50.

In one embodiment, the above described system is implemented in software (i.e., computer instructions) that are stored in a tangible computer readable memory and executed by at least one processor. Below is a description of a set of non-limiting use cases of the inventions.

In one implementation, a user 20 views a billboard 46 on the street with a code on it. The user then accesses an application on their mobile device 30 or calls a phone service and enters the code. The server 50 may include a call service center able to accept and process a user's phone call and code input. The user is then rewarded with a predetermined number of reward points. Moreover, the user 20 can take an image of the billboard and content recognition can be used to identify any advertisements associated with a reward. Likewise, information from the user device's GPS or wearable device could be used to identify the reward associated with the billboard and/or could be used to identify the user (whether registered or not).

In one implementation, a user 20 sees an advertisement 46 at a bus stop with a QR code on it. The user 20 photographs the QR code with a camera of the device 30 and as the QR code is recognized/processed by a mobile phone application of the device 30, which transmits an acknowledgement to the system server 50, and the user is rewarded with a predetermined reward.

In one implementation, a user 20 hears a radio commercial calling for certain action (e.g., recognize the audio via Perk properties). The user 20 opens the mobile application on the device 30, if not open already, and the application recognizes the audio of the advertisement and transmits an acknowledgement to the system server 50. The user is then provided with a predetermined reward.

In another implementation, a user 20 watches TV 44 and once a qualified commercial appears on the TV, the application on the mobile device 30 (could be open already or opened immediately) recognizes the audio and/or video from the commercial and transmits an acknowledgement to the system server 50. The user is then provided with a predetermined reward.

In yet another implementation, a user 20 is wearing a wearable device 30 such as Google Glass. The user watches a certain TV commercial or certain billboard/printed ad for which the wearable device detects the advertisement that the user is looking at. The wearable device 30 detects the advertisement that the user 20 has viewed, transmits an acknowledgement to the system server 50, and the user is provided with a predetermined reward. The user could also see that he/she is in a physical location that matches the visual content, which causes the user to receive a reward via a physical check-in as discussed above.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A method of acknowledging content from a user device, said method comprising:
using a component of the user device to detect an indicator associated with the content;
transmitting, from the user device, an acknowledgement that the indicator has been detected, the acknowledgement being transmitted to a server computer adapted to determine whether a reward should be provided to the user device based on the transmitted acknowledgement; and
receiving, at the user device, the reward from the server computer when it is determined that the reward should be provided to the user device.

2. The method of claim 1, wherein the content is printed content and said user device detects the indicator by activating a camera of the user device and taking an image of the indicator.

3. The method of claim 1, wherein the content is audio content and said user device detects the indicator by activating an audio content recognition device of the user device and capturing a portion of the audio.

4. The method of claim 1, wherein the content is visual content and said user device detects the indicator by activating a visual content recognition device of the user device and capturing a portion of the visual content.

5. The method of claim 1, wherein said indicator is a code identifying the content or reward and the user device detects the indicator upon inputting the code.

6. The method of claim 1, further comprising storing the reward in a memory of the user device.

7. The method of claim 6, wherein the reward comprises one of discount coupons, gift cards, cash, currency, free items and virtual goods, videos, access to premium content, the unlocking of features to a website or other service or content, or various forms of vouchers, incentives or loyalty points that is a reward for a user's action.

8. The method of claim 1,wherein the content is one of an advertisement or information at or about a particular location or an event.

9. A method of rewarding a user for engaging with content, the method comprising:
receiving, at server computer, an acknowledgement that the content was viewed or listened to by a user of a user device, the acknowledgement being received over a network connection;
deriving, by a processor of the server computer, a benefit to the user based on the received acknowledgement and stored information associated with the content; and
providing the benefit to the user device.

10. The method of claim 9, further comprising:
identifying the user device via a device ID, IP address or other identifier associated with the user device;
associating the derived benefit with the identified user device; and
storing the derived benefit on a storage medium.

11. The method of claim 9, further comprising:
identifying the user via a user account stored on a storage medium;
associating the derived benefit with the identified user; and
storing the derived benefit on the storage medium in the user account.

12. The method of claim 9, wherein the content is one of an advertisement or information at or about a particular location or an event.

13. The method of claim 9, wherein the benefit comprises one of discount coupons, gift cards, cash, currency, free items and virtual goods, videos, access to premium content, the unlocking of features to a website or other service or content, or various forms of vouchers, incentives or loyalty points that is a reward for a user's action.

14. The method of claim 9, wherein the benefit is provided to the user device by transmitting the benefit over the network connection to the user device.

15. The method of claim 9, wherein the benefit is provided to the user device by storing the benefit in a user account accessible by the user device.

16. A system of providing a reward to a user of said system, said system comprising:
a server computer adapted to:
receive an acknowledgement that content associated with the system was viewed or listened to by a user of a user device, the acknowledgement being received over a network connection;
derive, by a processor of the server computer, a benefit to the user based on the received acknowledgement and stored information associated with the content; and
provide the benefit to the user device.

17. The system of claim 16, wherein said server is further adapted to:
identify the user device via a device ID, IP address or other identifier associated with the user device;
associate the derived benefit with the identified user device; and
store the derived benefit on a storage medium.

18. The system of claim 16, wherein said server is further adapted to:
identify the user via a user account stored on a storage medium;
associate the derived benefit with the identified user; and
store the derived benefit on the storage medium in the user account.

19. The system of claim 16, wherein the server is adapted to provide the benefit to the user device by transmitting the benefit over the network connection to the user device.

20. The system of claim 16, wherein the server is adapted to provide the benefit to the user device by storing the benefit in a user account accessible by the user device.

21. The system of claim 16, wherein the content is one of an advertisement or information at or about a particular location or an event and the benefit is a reward that comprises one of discount coupons, gift cards, cash, currency, free items and virtual goods, videos, access to premium content, the unlocking of features to a website or other service or content, or various forms of vouchers, incentives or loyalty points that is a reward for a user's action.
